(19) United States
(12) Patent Application Publication
(10) Pub. No.: US 2026/0357945 A1
(43) Pub. Date: Nov. 12, 2026

(54) MOTORIZED ANGLE-ADJUSTABLE DISPLAY BRACKET

(71) Applicant: Jsyard Home Technology Co., LTD, Hangzhou, Zhejiang (CN)

(72) Inventors: Weiping Fan, Hangzhou (CN); Xuebin Kang, Hangzhou (CN)

(21) Appl. No.: 19/239,021

(22) Filed: Jun. 16, 2025

(30) Foreign Application Priority Data
May 12, 2025 (CN) 202510600928.1

(51) Int. Cl. F16M 11/18; F16M 13/02

(52) U.S. Cl. CPC F16M 11/18; F16M 13/022

(57) ABSTRACT

A motorized angle-adjustable display bracket, comprising a base, a lower arm, and an upper arm; a bottom of the base is provided with a fixing clamp, and the base is provided with a rotating part connected to the lower arm; a bottom end of the upper arm is rotatably connected to the lower arm; the upper arm comprises a connecting seat and an adapter seat, and the connecting seat and the adapter seat are rotatably connected via a linkage rod; an inner side of the linkage rod is provided with a telescopic rod rotatably connected to the connecting seat and the adapter seat; a lower side of the telescopic rod is provided with a telescopic rod decorative casing rotatably connected to the connecting seat and the adapter seat and matched with the linkage rod; the adapter seat is movably connected to a display mounting seat.

### TECHNICAL FIELD

The invention relates to the technical field of brackets, and in particular to a motorized angle-adjustable display bracket.

### BACKGROUND ART

With the rapid development of information technology, monitors, as an important interface for human-computer interaction, are increasingly used in a wide range of applications, from office, study to entertainment. Monitors have become an indispensable device in people's daily lives. However, traditional monitor brackets have the following shortcomings:
1. single adjustment method and insufficient flexibility:
traditional brackets usually use manual adjustment methods, and users need to manually adjust the joints of the bracket to change the angle of the monitor. This method is not only cumbersome to operate, but also difficult to control the adjustment accuracy, and it is difficult to meet users' precise requirements for the position and angle of the monitor.

Although some brackets use auxiliary devices such as gas spring rods to reduce the adjustment force, they still require manual operation by users, and the adjustment range is limited, and it is impossible to achieve flexible adjustment of the monitor in multiple directions.

2. Insufficient stability and potential safety hazards: traditional brackets are often fixed by clamping or bolting. During long-term use, they are prone to loosening, causing the monitor to shake or even fall, posing a safety hazard.

The base design of some brackets is not stable enough. When users frequently adjust the angle of the monitor, it is easy to cause the bracket to tilt or slide as a whole, affecting the user experience.

3. Lack of humanized design and poor user experience:
The cables of traditional brackets are usually exposed, which are easy to be entangled or damaged, affecting the appearance and posing safety hazards.

The adjustment parts of some brackets lack protective design, which is easy to accumulate dust and debris, affecting the service life.

Lack of decorative design makes it difficult to integrate with modern office or home environments.

Therefore, a motorized angle-adjustable display bracket is proposed to solve the current shortcomings.

### SUMMARY OF THE INVENTION

The technical problem to be solved by the invention is to overcome the defects of the above technology and provide a motorized angle-adjustable display bracket.

In order to solve the above technical problems, the technical solution provided by the invention is a motorized angle-adjustable display bracket, comprising a base, a lower arm, and an upper arm; a bottom of the base is provided with a fixing clamp, and the base is provided with a rotating part connected to the lower arm;
a bottom end of the upper arm is rotatably connected to the lower arm; the upper arm comprises a connecting seat and an adapter seat, and the connecting seat and the adapter seat are rotatably connected via a linkage rod; an inner side of the linkage rod is provided with a telescopic rod rotatably connected to the connecting seat and the adapter seat; a lower side of the telescopic rod is provided with a telescopic rod decorative casing rotatably connected to the connecting seat and the adapter seat and matched with the linkage rod; the adapter seat is movably connected to a display mounting seat.

As an improvement, the rotating part comprises a speed-reducing motor and a connecting shaft; the speed-reducing motor is arranged inside the base, with an output end thereof connected to the connecting shaft, and a bearing is provided between the connecting shaft and the speed-reducing motor; the lower arm is provided with a first connecting shaft sleeve fixedly connected to the connecting shaft.

As an improvement, the base is provided with a fixed sleeve, and the speed-reducing motor is coaxially arranged inside the fixed sleeve; the lower arm is sleeved with an upper cover threaded to an upper end of the fixed sleeve.

As an improvement, the lower arm is provided with a second connecting shaft sleeve matched with the upper arm.

As an improvement, the linkage rod and the telescopic rod decorative casing are arranged in parallel, and the linkage rod, the telescopic rod decorative casing, the connecting seat, and the adapter seat form a parallelogram structure.

As an improvement, the linkage rod is clamped with an upper arm decorative casing.

As an improvement, the telescopic rod decorative casing is provided with a first cable clamp.

As an improvement, the lower arm is provided with a second cable clamp.

As an improvement, it further comprises a hand controller connected to the speed-reducing motor and the telescopic rod, and a power adapter.

The advantages of the invention compared with the prior art are:
1. an electric adjustment mechanism is adopted, and the angle of the display can be precisely controlled through the hand controller. The user can easily control the operation of the speed-reducing motor and the telescopic rod through the button or knob on the hand controller to achieve accurate and convenient adjustment of the display in the horizontal and vertical directions, greatly simplifying the adjustment process and improving the adjustment efficiency. It is especially suitable for users who need to adjust the position of the display frequently.

2. The angle adjustment of the display in multiple degrees of freedom is achieved by driving the lower arm to rotate in the horizontal direction through the speed-reducing motor, and the upper arm to move in the vertical direction through the telescopic rod. Its adjustment range is wider, which can meet the user's diverse needs for the position and angle of the display in different usage scenarios.

3. The fixing clamp at the bottom of the base can be firmly fixed on the supporting plane to effectively prevent the bracket from sliding or tipping over. At the same time, a bearing is provided between the speed-reducing motor and the connecting shaft, and the precise matching of the connecting shaft sleeve and other components ensures the stability and accuracy of the bracket during the adjustment process, further improves the overall stability, and provides users with a safer and more reliable use experience.

4. The lower arm and the upper arm are respectively provided with cable clamps to fix and organize the cables, avoid the cables being messy, improve the safety of use, and facilitate subsequent maintenance and repair. The upper cover and the upper arm decorative casing and other parts not only play a decorative role, but also protect the internal parts, prevent dust and debris from entering and affecting normal work, and improve the overall aesthetics of the bracket. At the same time, the parallelogram structure design makes the various parts of the upper arm move in coordination during the rotation process, ensuring the stability and smoothness of the display angle adjustment, and improving the user's comfort.

5. The bracket has a simple structure and is easy to use. Through electric multi-angle precision adjustment, stable and safe structural design, and humanized detail processing, it significantly improves the convenience, stability, safety and user experience of the display bracket.

### BRIEF DESCRIPTION OF THE INVENTION

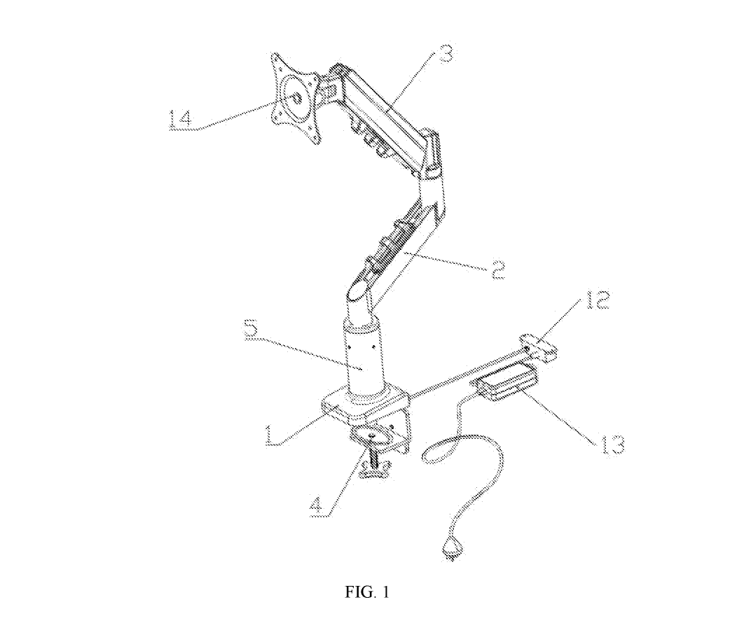

FIG. 1 is a first structural schematic diagram of the motorized angle-adjustable display bracket according to the invention.

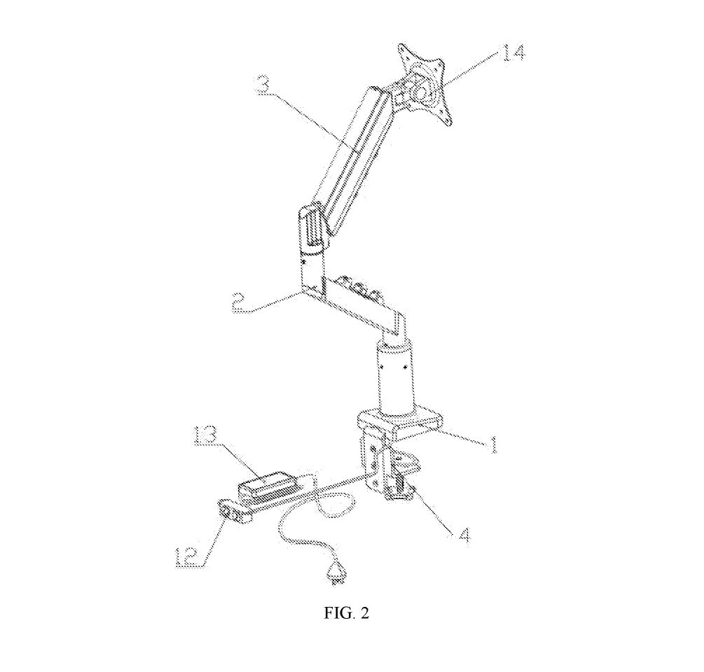

FIG. 2 is a second structural schematic diagram of the motorized angle-adjustable display bracket according to the invention.

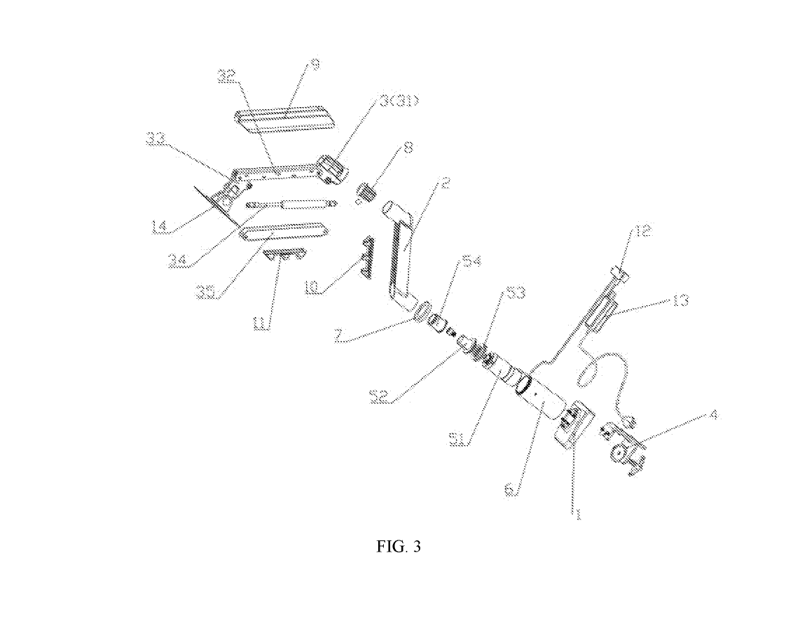

FIG. 3 is an exploded view of the motorized angle-adjustable display bracket according to the invention.

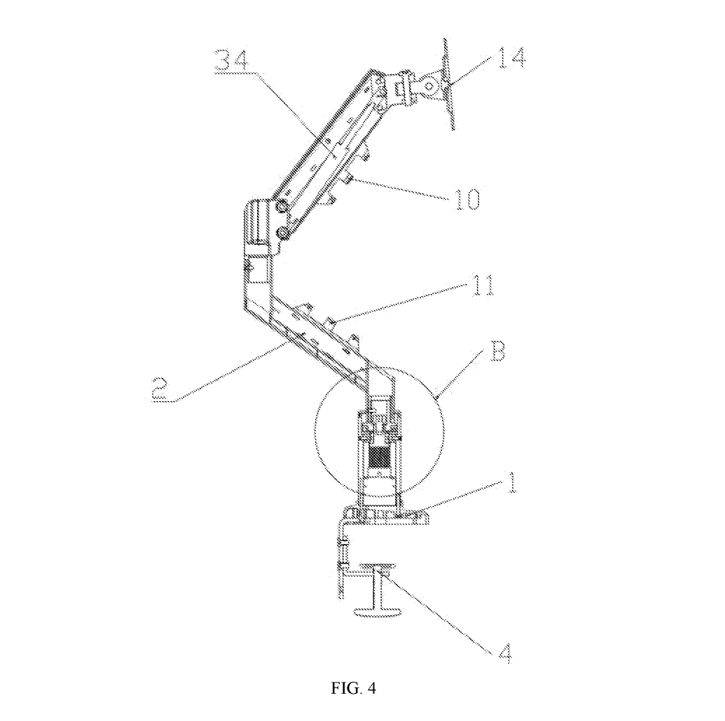

FIG. 4 is a schematic diagram of the internal structure of the motorized angle-adjustable display bracket according to the invention.

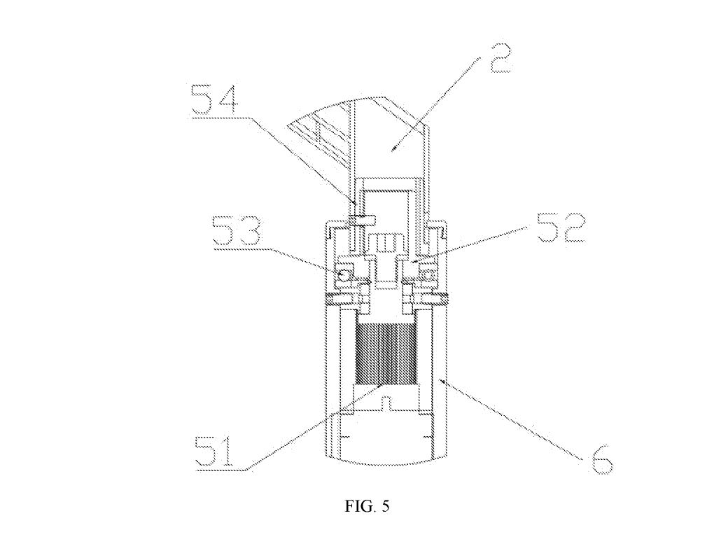

FIG. 5 is a partial enlarged view of part B in FIG. 4.

### AS SHOWN IN THE FIGURES

1 refers to the base; 2 refers to the lower arm;
3 refers to the upper arm; 31 refers to the connecting seat; 32 refers to the adapter seat; 34 refers to the telescopic rod; 35 refers to the telescopic rod decorative casing;
4 refers to the fixing clamp;
5 refers to the rotating part; 51 refers to the speed-reducing motor; 52 refers to the connecting shaft; 53 refers to the bearing; 54 refers to the first connecting shaft sleeve;
6 refers to the fixed sleeve; 7 refers to the upper cover; 8 refers to the second connecting shaft sleeve; 9 refers to the upper arm decorative casing; 10 refers to the first cable clamp; 11 refers to the second cable clamp; 12 refers to the hand controller; 13 refers to the power adapter; 14 refers to the display mounting seat.

### SPECIFIC EMBODIMENT OF THE INVENTION

In order to make the objectives, technical solutions, and advantages of the embodiments of the invention clearer, the technical solutions in the embodiments of the invention will be described clearly and completely hereinafter with reference to the drawings in the embodiments of the invention. Obviously, the described embodiments are part of the embodiments of the invention, rather than all of the embodiments. The components of the embodiments of the invention generally described and illustrated in the drawings herein may be arranged and designed in various different configurations.

In the description of the invention, it needs to be understood that the orientation or positional relationship indicated by the terms “center”, “up”, “down”, “left”, “right”, “vertical”, “horizontal”, “inner”, “outer”, etc. are based on the orientation or positional relationship shown in the drawings, which are only for the convenience of describing the invention and simplifying the description, rather than indicating or implying that the device or element referred to must have a specific orientation, be constructed and operated in a specific orientation, and therefore cannot be understood as a limitation of the invention. In addition, the terms “first”, “second”, and “third” are only used for descriptive purposes, and cannot be understood as indicating or implying relative importance or implicitly indicating the number of indicated technical features.

In addition, the terms “horizontal”, “vertical”, “dangling”, etc. do not mean that the component is required to be absolutely horizontal or hanging, but may be slightly inclined. For example, “horizontal” only means that its direction is more horizontal than “vertical”, it does not mean that the structure must be completely horizontal, but can be slightly inclined.

In the description of the invention, “plurality” means at least two.

In the invention, unless otherwise clearly defined and limited, the terms “provided”, “installed”, “connected” and other terms should be interpreted broadly; for example, it can be a fixed connection, it can be a detachable connection, or integrated; it can be a mechanical connection or an electrical connection; it can be a direct connection, or an indirectly connection through an intermediate medium, and it can be an internal communication between two elements or the interaction relationship between two elements. For those of ordinary skill in the art, the specific meaning of the above terms in the invention can be understood according to specific circumstances.

With reference to the figures, the invention provides a motorized angle-adjustable display bracket with the function of conveniently adjusting the position of the monitor at multiple angles to meet different usage requirements.

The brackets comprises a base 1, a lower arm 2, and an upper arm 3;
a bottom of the base 1 is provided with a fixing clamp 4; in implementation, the fixing clamp 4 firmly fixes the entire display bracket on a desktop or other supporting plane to ensure that the bracket is stably placed and prevent the display from falling due to shaking.

the base 1 is provided with a rotating part 5 connected to the lower arm 2;
specifically, the rotating part 5 comprises a speed-reducing motor 51 and a connecting shaft 52; the speed-reducing motor 51 is arranged inside the base 1 as a power source for the rotation of the lower arm 2. By controlling the operation of the speed-reducing motor 51, the connecting shaft 52 can be driven to rotate, and then the lower arm 2 can be rotated around the base 1 to achieve the angle adjustment of the display in the horizontal direction.

An output end of the speed-reducing motor 51 is connected to the connecting shaft 52, and a bearing 53 is provided between the connecting shaft 52 and the speed-reducing motor 51;
in implementation, the connecting shaft 52 is connected to an output end of the speed-reducing motor 51 to transmit the power of the speed-reducing motor 51. A bearing 53 is provided between the connecting shaft 52 and the speed-reducing motor 51 to reduce the friction force when the connecting shaft 52 rotates, making the rotation smoother, while also ensuring the rotation accuracy of the connecting shaft 52 and extending the service life of the components.

The lower arm 2 is provided with a first connecting shaft sleeve 54 fixedly connected to the connecting shaft 52; the first connecting shaft sleeve 54 is arranged in the lower arm 2 and fixedly connected to the connecting shaft 52. When the connecting shaft 52 rotates, the first connecting shaft sleeve 54 is driven to rotate, thereby realizing the relative rotation between the lower arm 2 and the base 1.

In implementation, the base 1 is provided with a fixed sleeve 6, and the speed-reducing motor 51 is coaxially arranged inside the fixed sleeve 6;
the fixed sleeve 6 is mounted on the base 1, and the speed-reducing motor 51 is coaxially arranged inside the fixed sleeve 6, providing a stable installation position for the reduction motor 51, ensuring the stability of the speed-reducing motor 51 during operation, and also playing a certain protective role to prevent external factors from causing damage to the speed-reducing motor 51.

The lower arm 2 is sleeved with an upper cover 7 threaded to an upper end of the fixed sleeve 6. The upper cover 7 can seal the rotating part 5 to prevent dust, debris, etc. from entering the interior of the fixed sleeve 6 to affect the normal operation of the speed-reducing motor 51 and the connecting shaft 52, while also improving the aesthetics of the entire bracket.

Further, the lower arm 2 is provided with a second cable clamp 11 for fixing and arranging the wires connected from the base 1 to the inside of the lower arm 2, so as to avoid the wires being in disarray, improve the safety of use, and facilitate subsequent maintenance and inspection.

A bottom end of the upper arm 3 is rotatably connected to the lower arm 2, so that the upper arm 3 rotates around the lower arm 2 to achieve angle adjustment of the display.

The lower arm 2 is provided with a second connecting shaft sleeve 8 matched with the upper arm 3 to ensure the stability of the connection between the upper arm 3 and the lower arm 2.

The upper arm 3 comprises a connecting seat 31 and an adapter seat 32, and the connecting seat 31 and the adapter seat 32 are rotatably connected via a linkage rod 33; an inner side of the linkage rod 33 is provided with a telescopic rod 34 rotatably connected to the connecting seat 31 and the adapter seat 32; a lower side of the telescopic rod 34 is provided with a telescopic rod decorative casing 35 rotatably connected to the connecting seat 31 and the adapter seat 32 and matched with the linkage rod 33; the linkage rod 33 and the telescopic rod decorative casing 35 are arranged in parallel, and the linkage rod 33, the telescopic rod decorative casing 35, the connecting seat 31, and the adapter seat 32 form a parallelogram structure.

In specific implementation, the connecting seat 31 and the adapter seat 32 are rotatably connected via a linkage rod 33, so that the upper arm 3 can achieve a certain angle change by rotating with the linkage rod 33, thereby further adjusting the angle of the display in the vertical direction.

By setting the telescopic rod 34, the upper arm 3 can be moved in the vertical direction, so as to adjust the angle of the display in the vertical direction.

The telescopic rod decorative casing 9 not only serves as a decoration, but also protects the components inside the telescopic rod 34. At the same time, it is arranged in parallel with the linkage rod 33, and together with the connecting seat 31 and the adapter seat 32, it forms a parallelogram structure, ensuring the movement coordination of various parts of the upper arm 3 during the rotation process, making the angle adjustment of the display more stable and smooth.

Further, the linkage rod 33 is clamped with an upper arm decorative casing 9 to decorate and protect the linkage rod 33 and other internal components, thereby improving the aesthetics and durability of the entire upper arm 3.

The telescopic rod decorative casing 35 is provided with a first cable clamp 10 for fixing and arranging the cables connected from the lower arm 2 to the inside of the upper arm 3 to avoid entanglement and damage of the cables, thereby improving the safety and aesthetics of use.

The adapter seat 32 is movably connected to a display mounting seat 31 for mounting and fixing the display, and the position and angle of the display can be conveniently adjusted to meet different usage requirements.

It further comprises a hand controller 12 connected to the speed-reducing motor 51 and the telescopic rod 34, and a power adapter 13.

Specifically, the hand controller 12 is connected to the speed-reducing motor 51, and the user can conveniently control the operation of the speed-reducing motor 51 through the hand controller 12, thereby achieving the angle adjustment of the display. In this embodiment, the hand controller 12 is generally provided with various buttons or knobs for controlling the rotation direction and speed of the motor 51, and the operation is simple and convenient.

The power adapter 13 provides a stable power supply for the electric system of the entire display bracket. The power adapter 13 can convert the mains electricity into a voltage and current suitable for the bracket, ensuring that the components such as the speed-reducing motor 51 can work normally.

When the invention is in specific implementation:
when the user issues a horizontal angle adjustment command through the hand controller 13, the hand controller 13 transmits a signal to the speed-reducing motor 51, and the speed-reducing motor 51 starts to operate as a power source for the rotation of the lower arm 2.

The output end of the speed-reducing motor 51 drives the connecting shaft 52 to rotate. Since a bearing 53 is provided between the connecting shaft 52 and the speed-reducing motor 51, the friction force of the connecting shaft 52 when rotating is reduced, making the rotation smoother, while ensuring the rotation accuracy of the connecting shaft 52 and extending the service life of the components. The rotation of the connecting shaft 52 drives the rotation of the first connecting shaft sleeve 54, thereby realizing the rotation of the lower arm 2 around the base 1, and realizing the adjustment of the angle of the bracket in the horizontal direction.

When the display needs to be adjusted in the vertical direction, the user issues a corresponding command through the hand controller 13; at this time, when the telescopic rod 34 is extended or shortened, the connecting seat 31 and the adapter seat 32 are driven to move relative to each other, thereby changing the angle between the upper arm 3 and the lower arm 2, and finally achieving the angle adjustment of the display in the vertical direction.

The advantages of the invention compared with the prior art are:
An electric adjustment mechanism is adopted, and the angle of the display can be precisely controlled through the hand controller. The user can easily control the operation of the speed-reducing motor and the telescopic rod through the button or knob on the hand controller to achieve accurate and convenient adjustment of the display in the horizontal and vertical directions, greatly simplifying the adjustment process and improving the adjustment efficiency. It is especially suitable for users who need to adjust the position of the display frequently.

The angle adjustment of the display in multiple degrees of freedom is achieved by driving the lower arm to rotate in the horizontal direction through the speed-reducing motor, and the upper arm to move in the vertical direction through the telescopic rod. Its adjustment range is wider, which can meet the user's diverse needs for the position and angle of the display in different usage scenarios.

The fixing clamp at the bottom of the base can be firmly fixed on the supporting plane to effectively prevent the bracket from sliding or tipping over. At the same time, a bearing is provided between the speed-reducing motor and the connecting shaft, and the precise matching of the connecting shaft sleeve and other components ensures the stability and accuracy of the bracket during the adjustment process, further improves the overall stability, and provides users with a safer and more reliable use experience.

The lower arm and the upper arm are respectively provided with cable clamps to fix and organize the cables, avoid the cables being messy, improve the safety of use, and facilitate subsequent maintenance and repair. The upper cover and the upper arm decorative casing and other parts not only play a decorative role, but also protect the internal parts, prevent dust and debris from entering and affecting normal work, and improve the overall aesthetics of the bracket. At the same time, the parallelogram structure design makes the various parts of the upper arm move in coordination during the rotation process, ensuring the stability and smoothness of the display angle adjustment, and improving the user's comfort.

The bracket has a simple structure and is easy to use. Through electric multi-angle precision adjustment, stable and safe structural design, and humanized detail processing, it significantly improves the convenience, stability, safety and user experience of the display bracket.

The invention and the embodiments thereof are described hereinabove, and this description is not restrictive. What is shown in the drawings is only one of the embodiments of the invention, and the actual structure is not limited thereto. All in all, structural methods and embodiments similar to the technical solution without deviating from the purpose of the invention made by those of ordinary skill in the art without creative design shall all fall within the protection scope of the invention.

What is claimed is:

1. A motorized angle-adjustable display bracket, comprising a base, a lower arm, and an upper arm;
a bottom of the base is provided with a fixing clamp, and the base is provided with a rotating part connected to the lower arm; a bottom end of the upper arm is rotatably connected to the lower arm; the upper arm comprises a connecting seat and an adapter seat, and the connecting seat and the adapter seat are rotatably connected via a linkage rod; an inner side of the linkage rod is provided with a telescopic rod rotatably connected to the connecting seat and the adapter seat; a lower side of the telescopic rod is provided with a telescopic rod decorative casing rotatably connected to the connecting seat and the adapter seat and matched with the linkage rod; the adapter seat is movably connected to a display mounting seat.

2. The motorized angle-adjustable display bracket of claim 1, wherein the rotating part comprises a speed-reducing motor and a connecting shaft; the speed-reducing motor is arranged inside the base, with an output end thereof connected to the connecting shaft, and a bearing is provided between the connecting shaft and the speed-reducing motor; the lower arm is provided with a first connecting shaft sleeve fixedly connected to the connecting shaft.

3. The motorized angle-adjustable display bracket of claim 2, wherein the base is provided with a fixed sleeve, and the speed-reducing motor is coaxially arranged inside the fixed sleeve; the lower arm is sleeved with an upper cover threaded to an upper end of the fixed sleeve.

4. The motorized angle-adjustable display bracket of claim 1, wherein the lower arm is provided with a second connecting shaft sleeve matched with the upper arm.

5. The motorized angle-adjustable display bracket of claim 1, wherein the linkage rod and the telescopic rod decorative casing are arranged in parallel, and the linkage rod, the telescopic rod decorative casing, the connecting seat, and the adapter seat form a parallelogram structure.

6. The motorized angle-adjustable display bracket of claim 5, wherein the linkage rod is clamped with an upper arm decorative casing.

7. The motorized angle-adjustable display bracket of claim 6, wherein the telescopic rod decorative casing is provided with a first cable clamp.

8. The motorized angle-adjustable display bracket of claim 1, wherein the lower arm is provided with a second cable clamp.

9. The motorized angle-adjustable display bracket of claim 1, wherein it further comprises a hand controller connected to the speed-reducing motor and the telescopic rod, and a power adapter.
